(19) United States
(12) Patent Application Publication
(10) Pub. No.: US 2018/0339703 A1
(43) Pub. Date: Nov. 29, 2018

(54) Vehicle with remote-controlled operating mode

(71) Applicant: Sucxess LLC, Birmingham, MI (US)

(72) Inventor: Axel Nix, Birmingham, MI (US)

(73) Assignee: Sucxess LLC, Birmingham, MI (US)

(21) Appl. No.: 15/990,209

(22) Filed: May 25, 2018

Related U.S. Application Data
(60) Provisional application No. 62/511,531, filed on May 26, 2017.

(51) Int. Cl. B60W 30/06; B60W 10/04; B60W 10/18; B60W 10/20; G05D 1/00; G05D 1/02

(52) U.S. Cl. CPC B60W 30/06; B60W 2710/10; B60W 10/18; B60W 10/20; G05D 1/0011; G05D 1/0223; G05D 1/0246; B60W 2420/42; B60W 2550/10; B60W 2710/18; B60W 2710/20; B60W 2900/00; B60W 2420/54; B60W 2422/00; G05D 2201/0212; B60W 10/04

(57) ABSTRACT

A vehicle logistic system provides remote operation of self-propelled vehicles in the absence of a human driver. The logistic system operates with a vehicle which includes an accelerator pedal operatively connected to a longitudinal motion controller, a brake pedal operatively connected to the longitudinal motion controller, a steering wheel operatively connected to a lateral motion controller, and an automated vehicle processing module operatively connected to the longitudinal motion controller and to the lateral motion controller. The vehicle is configured to operate in different operating modes. The operating modes include a regular mode and a remote-controlled mode. The automated vehicle processing module is configured to control the longitudinal motion and lateral motion of the vehicle based on vehicle motion instructions received wirelessly from a server while the vehicle is operating in the remote control mode.

### TECHNICAL FIELD

The present disclosure relates to motor vehicles, and more particularly, to self-propelled motor vehicles operable in a regular mode and in a remote-controlled mode.

### BACKGROUND

For more than a century, the method by which newly manufactured vehicles have been transported to their end customers has remained largely unchanged. Once assembly of a vehicle is completed at the end of an assembly line, the new vehicle is manually driven by a human driver to a storage lot. There, vehicles are usually parked one behind another in lines of ten or more vehicles until they are loaded onto railcars or trucks.

Shipment of a vehicle from the vehicle manufacturer's plant to the end customer may involve several steps: A new vehicle may be transported by train to a harbor. There, the vehicle may be loaded onto a ferry for overseas shipment. At the receiving harbor the vehicle may be loaded onto a second train, then from the train onto a truck by which it is ultimately delivered to a vehicle dealership. Each change of transportation mode typically involves an intermediate storage step, i.e. it requires the vehicle to be manually driven to and from a parking lot between unloading and loading. The use of human drivers during shipment is time-consuming and expensive. Vehicles are prone to be damaged, e.g. while a driver enters and exits the vehicles. The new vehicles may be driven aggressively, causing unnecessary wear and tear. Human error may cause vehicles to get lost, e.g. when inadvertently driven into a wrong parking line.

Rental car companies face similar challenges in their parking lots. Here, also, cars are parked one behind another in lines, creating a form of automotive FIFO buffer. Unfortunately, such FIFO buffers are inefficient, as every vehicle has to be manually driven forward by one car length for every car that is removed from the buffer. To keep a lane of n vehicles completely filled all n vehicles have to be moved every time a vehicle is removed from the buffer, which is impractical.

More recently, driving automation systems have been known which allow the driver of a so equipped vehicle to hand operation of the vehicle to an automated driving system (ADS). The automated driving system includes hardware and software that are collectively capable of performing, on a sustained basis, the dynamic driving task (DDT). The dynamic driving task includes all of the real-time operational and tactical functions required to operate the vehicle. The SAE J3016 recommended practice defines levels to which a vehicle has been automated, ranging from SAE level 0 (“No Automation”) to SAE level 5 (“Full Automation”).

Driving automation systems include adaptive cruise control (ACC) systems that control longitudinal motion of a vehicle, allowing it to slow down and follow a preceding vehicle based on sensors inputs. Sensors frequently used for longitudinal motion control include radar sensors, lidar sensors, and machine vision cameras. Lane Assist Systems control lateral motion of the vehicle.

Automated parking systems have been proposed, for example in US 2015/0088360 which is hereby incorporated by reference in its entirety. The proposed automated parking procedure of a motor vehicle involves transferring a command to activate the automated parking procedure using a communication link between an operator situated outside the motor vehicle and the motor vehicle. Before beginning the automated parking procedure of the motor vehicle the target position and/or last driven trajectory of the motor vehicle is stored in a storage device. The motor vehicle then performs the parking procedure autonomously from the start position using the stored data after the first activation of the automated parking procedure.

A method of moving autonomous or driverless vehicles parked in a parking area in columns spaced too closely to allow drivers to enter or exit is disclosed in U.S. Pat. No. 9,139,199 which is hereby incorporated by reference thereto in its entirety.

Many automated driving systems are designed around on-road driving scenarios. “On-road” refers to publicly accessible roadways (including parking areas and private campuses that permit public access) that collectively serve users of vehicles of all classes and driving automation levels (including no driving automation), as well as motorcyclists, pedal cyclists, and pedestrians. Automated driving systems automate tasks such as driving in a traffic jam, freeway driving, or parking in public parking lots. Consequently, the proposed solutions are complex to ensure that they can safely operate wherever the driver may take the vehicle.

### SUMMARY

The present disclosure provides a solution that allows driverless, remote-controlled operation of motor vehicles within special-use environments, even if those vehicles are insufficiently equipped to perform automated on-road driving tasks.

The present disclosure further provides an improved vehicle logistics system which automates the previously labor-intensive manual movement of vehicles between a vehicle assembly plant and a vehicle dealership. The disclosed system can be beneficially applied to other use-cases. The system may, for example, be used to automate movement of self-propelled vehicles in rental car lots or movement through car wash facilities.

An exemplary vehicle logistic system includes a vehicle having an accelerator pedal operatively connected to a longitudinal motion controller, a brake pedal operatively connected to the longitudinal motion controller, and a steering wheel operatively connected to a lateral motion controller. An automated vehicle processing module is operatively connected to the longitudinal motion controller and to the lateral motion controller. The vehicle is configured to operate in different operating modes, the operating modes including a regular mode and a remote-controlled mode. A server is wirelessly communicating with the automated vehicle processing module. A stationary sensor is operatively connected to the server. The sensor has a field of view which includes a path of the vehicle. The server is configured to processes data received from the stationary sensor, to determine a position of the vehicle, and to determine the presence of objects within the path of the vehicle. Based thereon, the server communicates vehicle motion instructions to the automated vehicle processing module. The automated vehicle processing module is configured to control the longitudinal motion and lateral motion of the vehicle based on the vehicle motion instructions received from the server while the vehicle is operating in the remote control mode.

Within the vehicle logistic system the server may send vehicle motion instructions which include distance information. The vehicle may then follow the vehicle motion instructions by controlling the vehicle's speed. While moving, the vehicle may determine its position while following the vehicle motion instruction by evaluating at least one dead reckoning sensor.

The stationary sensor which is used to obtain a precise vehicle position may be attached to a ceiling structure of an ocean ferry or a railcar to support self-propelled movement of vehicles therein. The vehicle motion instructions may cause the vehicle to move from an area proximal to the end of a vehicle assembly line to a parking area within a vehicle assembly plant. Alternatively, the vehicle motion instructions cause the vehicle to move self-propelled through a car wash facility.

The present disclosure also presents a vehicle which includes an accelerator pedal operatively connected to a longitudinal motion controller, a brake pedal operatively connected to the longitudinal motion controller, a steering wheel operatively connected to a lateral motion controller, and an automated vehicle processing module operatively connected to the longitudinal motion controller and to the lateral motion controller. The vehicle is configured to operate in different operating modes. The operating modes include a regular mode and a remote-controlled mode. The automated vehicle processing module is configured to control the longitudinal motion and lateral motion of the vehicle based on vehicle motion instructions received wirelessly from a server while the vehicle is operating in the remote control mode.

The vehicle may further include a longitudinally arranged camera having a field of view which includes a portion of a surface on which the vehicle is moving. An image processing module may be operatively connected to the camera, the image processing module being configured to determine, by evaluation of images captured by the camera, a position of the vehicle relative to a visible structure or marking on the surface. The the visible structure or marking may be a taxiway centerline marking or a longitudinal structure within a railcar.

The vehicle may be configured to enable a function while in remote controlled mode that is not being executed while in regular mode. Vice versa, the vehicle may be configured to suppress a function while in remote controlled mode that is being executed while in regular mode. The vehicle may be configured to not travel further than a predetermined distance and/or not longer than for a predetermined time after receiving a vehicle motion instruction.

The vehicle may be configured to stop when communication with the server is lost. The vehicle may be configured to transition from the remote control mode to the regular mode when the brake pedal is activated.

The following detailed description of the invention is merely exemplary in nature and is not intended to limit the invention or the application and uses of the invention. Furthermore, there is no intention to be bound by any theory presented in the preceding background of the invention or the following detailed description of the invention.

### BRIEF DESCRIPTION OF THE DRAWINGS

FIG. 1 is an illustrative diagram showing aspects of an automated vehicle logistics system.

FIG. 2 is a diagram showing a self-propelled vehicle within the field of view of a stationary sensor.

FIG. 3 is a block diagram illustrating the interaction between a vehicle and a stationary infrastructure.

FIG. 4 is a sequence diagram showing aspects of the communication between a server and a remotely operated vehicle.

FIG. 5 is a sequence activity diagram showing an alternative communication scheme between a server and a remotely operated vehicle.

FIG. 6 is a state diagram illustrating operating modes of a vehicle.

FIG. 7 is a block diagram illustrating components related to the longitudinal and lateral motion control of a vehicle.

FIG. 8 is a dashboard camera image showing an inside view of a vehicle transport railcar.

FIG. 9 is a table showing an association of special use environments with activation/deactivation conditions and activated/suppressed vehicle functions.

### DETAILED DESCRIPTION

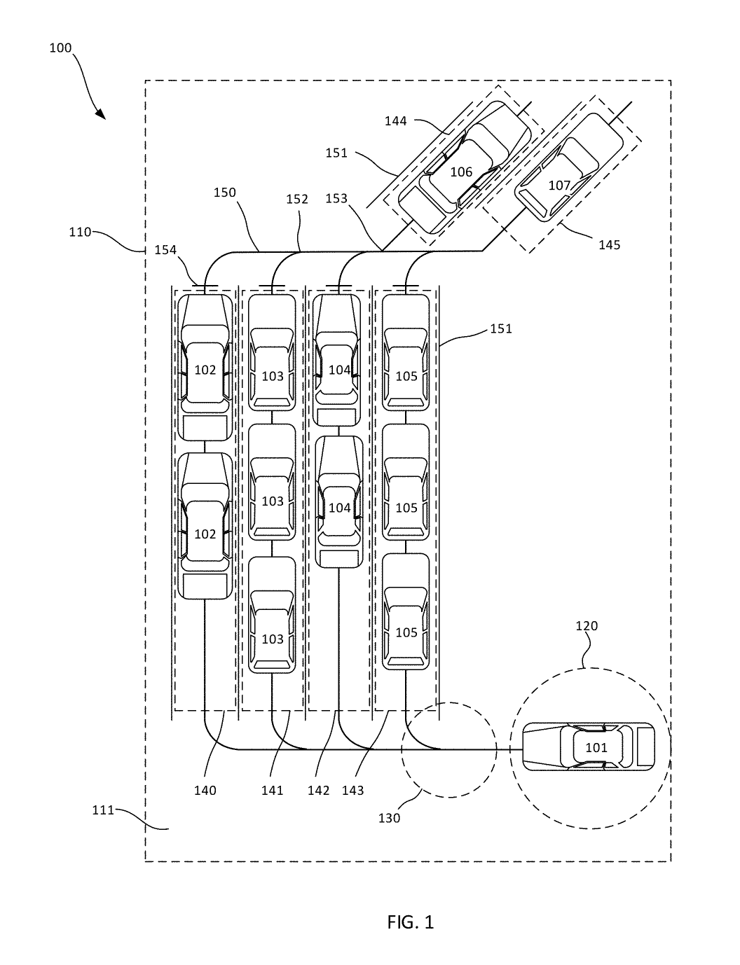

An exemplary automated vehicle logistics system 100 is schematically shown in FIG. 1. The system is implemented within the confines of a parking lot 111. The parking lot 111 may be inaccessible to the public. The perimeter of the parking lot 111 may be protected by a physical barrier 110, e.g. a fence or a wall, to prevent public access. Typically, the term “on-road” refers to publicly accessible roadways (including parking areas and private campuses that permit public access) that collectively serve users of vehicles of all classes and driving automation levels (including no driving automation), as well as motorcyclists, pedal cyclists, and pedestrian. The parking lot 111 may thus be considered “off-road”, since public access may be explicitly denied.

Within the automated vehicle logistics system, vehicles 101-107 move, without a driver present, self-propelled from an origin 120 to one or more destinations 144, 145. The vehicles 101-107 are self-propelled road and off-road vehicles suitable for the transportation of passengers and/or property. The vehicle propulsion is provided by an engine or a motor, usually by an internal combustion engine, by an electric motor, or by some combination of the two, such as found in hybrid electric vehicles and plug-in hybrids. In this paper, the terms engine and motor will be used interchangeably to refer to a propulsion mechanism.

The vehicles 101-107 may be equipped with automated driving systems. For example, the vehicles 101-107 may be equipped with a driver assistance system such as a lane-keeping or an emergency braking system. The vehicles 101-107 may also be equipped with automated driving systems that allow partial, conditional, high or full driving automation. However, the vehicles 101-107 need not be equipped with any driving automation system for on-road use.

The vehicles 101-107 are preferably of a “drive-by-wire” type and equipped with actuators that allow self-propelled longitudinal and lateral motion. In particular, the vehicles 101-107 may be equipped with a power steering system which includes an actuator that can directly or indirectly turn the vehicle's steering wheel without a driver input. Similarly, the vehicles 101-107 may be equipped with actuators that allow accelerating the vehicle without the need for a human driver to press an accelerator pedal and provide decelerating the vehicle without pressing a brake pedal. Vehicles 101-107 may have a transmission. If so, the vehicles will also provide an actuator that allows operating the transmission without an operator moving a shift-lever. In essence, the vehicles 101-107 are able to move from an origin to a destination along a path without a human driver being present to manipulate control inputs.

Many modern motor vehicles use drive-by-wire actuators, even if the vehicle has no driving automation system or limited driving automation that does not allow the vehicle to operate on-road without the presence of a human driver. The automated vehicle logistics system 100 is intended to be used with vehicles 101-107 that have drive-by-wire systems for longitudinal and lateral motion, but which may not have the necessary sensors and/or processing resources to operate on-road without a human driver being in control.

The automated vehicle logistics system 100 may be used in various applications. The system may, for example, be used to automate the movement of newly manufactured vehicles within a vehicle assembly plant. In that scenario, the origin 120 of a vehicle 101 may be the end of a manufacturing line or a dedicated drop-off location near the end of a manufacturing line. The destination 144, 145 may be a pick-up location within the perimeter of the vehicle assembly plant. The destination 144, 145 may, for example, be a loading ramp or pick-up location from which the vehicles 106, 107 are manually driving onto a railcar or onto a truck for further long distance transportation. The destination 144, 145 may also be a railcar or the bed of a truck itself.

Newly manufactured vehicles may be temporarily parked in lanes 140-143 according to their final destination while awaiting further transport. For example, a first set of vehicles 102 waiting to be loaded onto a first train to a first destination may be parked in a first parking lane 140. At the same time, a second set of vehicles 103 is parked in a second lane 141 waiting to be loaded onto a truck to a second destination. The parking lanes 140-143 may act as first-in, first-out (FIFO) buffers. That is, the first vehicle driven into a lane 140-143 is also the first vehicle to be extracted from the respective lane 140-143.

The parking lot 111 may be marked with visible markings 150-154. The markings may include taxiway centerline markings 150 which indicate a visible path for the vehicles 101-107 to follow. The centerline markings 150 may include holding position markings 154 which indicate designated locations at which a vehicle may need to stop. The taxiway centerline markings may include merge segments 152 where two or more centerlines merge and split segments 153 where a centerline splits into two or more centerlines. The visible markings may also include lane boundary markings 151. The taxiway centerline markings may be drawn in a color, e.g. in red or blue, which is not commonly used in other lane markings. The unique color may aid the visual detection of the centerline markings within an image processing system.

An alternative use of the vehicle logistics system 100 is the temporary storage of vehicles 101-107 when the vehicles are changing transport modes, for example when the vehicles 101-107 are loaded from a railcar onto an ocean ferry or vice versa within the confines of a harbor.

Yet another alternative use of the vehicle logistics system 100 is the operation of a rental car lot. Here, a returned vehicle 101 may be manually driven to and dropped off at a rental car return location 120 by a rental car customer. The vehicle may then, without a human driver therein, follow a path through the rental car lot into a storage lane 140-143. The storage lanes may be organized by vehicle type. For example, SUVs 102 may be stored in a first lane 140, small cars 103 may be stored in a second lane 141, midsize cars 104 may be stored in a third lane 142, and so forth. Rental cars may move, without a human driver, to pick-up locations 144, 145 from where they are picked up and manually driven by their human renter on-road.

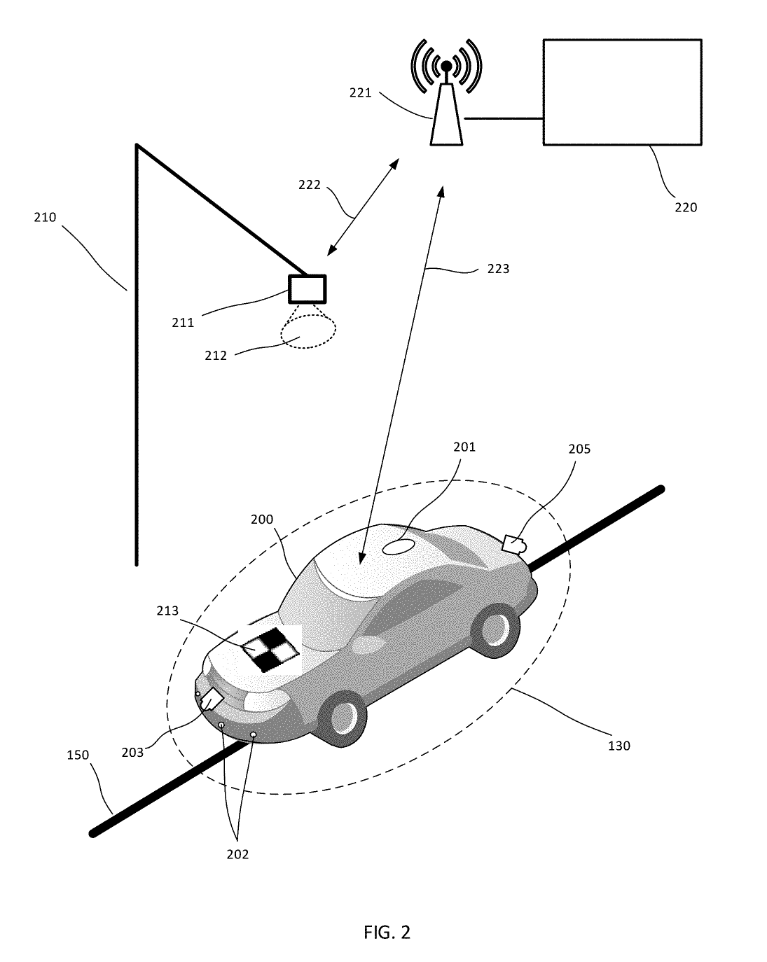

A more detailed view of a self-propelled vehicle 200 traveling without a human driver along a centerline 150 is schematically shown in FIG. 2. Here, the vehicle 200 has several sensors for sensing environment around the vehicle. The sensors may include ultrasonic distance sensors 202, a forward facing camera 203, and a rearward facing camera 205. Such sensors are commonly used in vehicles today, in particular to aid human drivers in parking the vehicle 200 when under human control. The vehicle may include a global navigation satellite system (GNSS) 201 to determine the vehicle's position. Notably, such sensors may be present in vehicles without automated on-road driving systems.

As the vehicle travels along the centerline 150 it may reach a checkpoint 130. The area around the checkpoint 130 is in view 212 of a stationary sensor 211. The stationary sensor 211 is preferably mounted onto an elevated structure 210 such as a lamp pole, the ceiling of a railcar, an elevated structure within an ocean ferry, or the like. The field of view 212 of the stationary sensor 211 thus includes an elevated view of the vehicle 200. The vehicle 200 and the stationary sensor 211 are in communication 222 through a base station 221 with a server 220. The base station 221 may, for example, be a wireless router, a cellular tower, or a Dedicated Short Range Communication (DSRC) base station.

The stationary sensor 211 is used to determine the position of the vehicle 200 within its view 212. The stationary sensor 211 may, for example, be a camera, a Lidar sensor, or a radar sensor. The stationary sensor 211 may comprise or be couple to a processing module that evaluates data from the stationary sensor 211, identifies the vehicle 200 within the view 212 of the sensor 211, and determines the position of the vehicle 200.

For example, the stationary sensor 211 may be a camera which is operatively connected to an image processing module. The image processing module may utilize computer vision to identify the vehicle 200 within one or more images it receives from the camera sensor 211. In particular, the image processing module may determine the image coordinates of the vehicle within an image received from the camera sensor 211. The image processing module may transform the image coordinates to real world coordinates using a suitable coordinate system. The transformation of image coordinates to real world coordinates is based on knowledge of the position of the sensor 211 in real world coordinates.

The real world position of the vehicle 200 may e.g. be expressed in latitude and longitude. Alternatively, a cartesian coordinate system may be used which may use an origin within the area of the vehicle's 200 automated operation. For example, the real world position of the vehicle 200 may be expressed as an x/y/z position within an ocean ferry.

A visible target 213 may be temporarily placed onto the vehicle 200 to improve the accuracy with which the stationary sensor 211 can determine the position of the vehicle 200 as it travels along its path marked by the centerline 150. The visible target 213 may include a black and white checkerboard or other high-contrast visual marking which aids a computer vision system in recognizing the target and its position in a camera image. The visible target 213 may be placed onto the vehicle 200 before operation in a remote-controlled operating mode and may be removed from the vehicle 200 after remote-controlled operation has been concluded. The visible target 213 may include identifying information such as a serial number or an identification code.

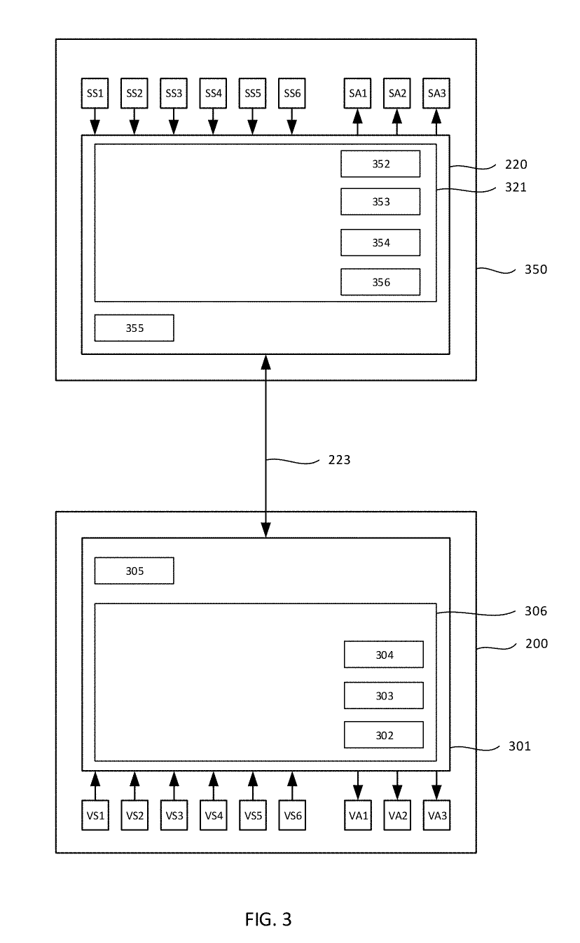

Referring now to FIG. 3, the interaction between the vehicle 200 and a stationary infrastructure 350 is schematically illustrated in more detail. As shown, the vehicle 200 includes a plurality of vehicle sensors VS1 . . . VS6 and vehicle actuators VA1 . . . VA3. The vehicle sensors may include one or more sensors suitable to determine a position of the vehicle. Such sensors may include a global navigation satellite system (GNSS). The sensors may include sensors to aid dead reckoning of the vehicle, e.g. wheel pulse sensors, wheel speed sensors, transmission speed sensors, steering wheel angle sensors, and steering angle sensors. Preferably, the sensors include an inertial measurement unit capable to measuring 6 degrees of freedom, including acceleration along and rotation around the vehicle's longitudinal, lateral, and vertical axis. The sensors may further include object detection sensors such as cameras, radar sensors, lidar sensors, and ultrasonic sensors. The sensors may include an accelerator pedal position sensor and a brake pedal position sensor.

The vehicle sensors VS1 . . . VS6 are operatively connected to a vehicle processing module 301. The vehicle processing module 301 may be formed as one integral electronic control module or by two or more electronic control modules which interact with one another. The vehicle processing module 301 may include one or more processors 306 configured to perform instructions, commands and other routines in support of the processes and functions described herein. For instance, the vehicle processing module 301 may be configured to execute instructions to provide features such as vehicle localization and dead reckoning 302, lateral control 303, and longitudinal control 304. Such instructions and other data may be maintained in a non-volatile manner using a variety of types of a computer-readable storage medium 305. The computer-readable medium 305 (also referred to as a processor-readable medium or storage) includes any non-transitory medium (e.g., a tangible medium) that participates in providing instructions or other data that may be read by the processor 306 of the vehicle processing module 301. Computer-executable instructions may be compiled or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

The vehicle actuators VA1 . . . VA3 may include actuators that convert electrical signals into a mechanical motion, e.g. motors and valves. The vehicle actuators VA1 . . . VA3 may include a power steering actuator, a brake actuator, and a propulsion motor.

The vehicle processing module 301 communicates through a wireless communication link 223 with a server 220. The server 220 is part of an infrastructure 350. The infrastructure 350 may further include a plurality of stationary sensors SS1 . . . SS6 and stationary actuators SA1 . . . SA3.

The stationary sensors may be of the type of stationary sensor 211 as discussed above. Stationary sensors may also include proximity sensors, motion sensors, door contact switches and the like which can indicate a breach of a secured access area. The stationary sensors SS1 . . . SS6 may be arranged spaced apart along the desired path of a self-propelled vehicle and may have overlapping fields of view. Each stationary sensor SS1 . . . SS6 may be associated with a checkpoint to determine the exact position of the vehicle when in view of a stationary sensor.

The stationary sensors may be arranged so as to have overlapping fields of view and may be configured to detect the self-propelled vehicle as well as obstacles, in particular humans, along the path of the self-propelled vehicle. The stationary sensors are operatively connected to the server 220. The server 220 includes one or more server processors 321 configured to perform instructions, commands and other routines in support of the functions and processes described herein. For instance, the server 220 may be configured to execute instructions to provide features such as vehicle detection 352, coordinate transformation 353, vehicle path monitoring 354, and vehicle route calculation 356.

The infrastructure 350 may further comprise one or more infrastructure actuators SA1 . . . SA3. Infrastructure actuators may include garage doors, boom barriers, visual and audible alert systems and the like. The infrastructure actuators SA1 . . . SA3 may be used to selectively prevent humans from entering an area in which vehicles operate in a remote-controlled mode. Alternatively or additionally, the infrastructure actuators may be used to alert humans to the potential danger of automated vehicle movement in their vicinity.

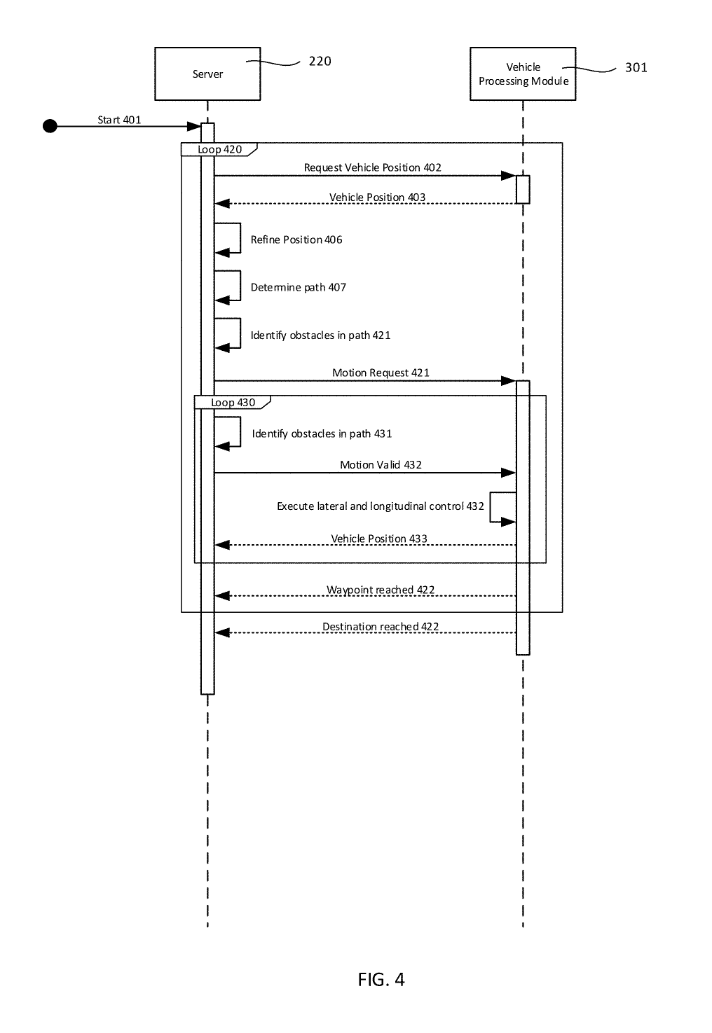

Referring now to FIG. 4, a sequence diagram shows an exemplary interaction between the infrastructure 350 and the vehicle 200, or more specifically the interaction between the server 220 and vehicle processing module 301. The illustrated interaction is suitable for use with vehicles 200 that are insufficiently equipped for automated on-road operation and in which substantial parts of the automated driving task are controlled by the infrastructure. The illustrated interaction is also suitable for use with vehicles 200 which are capable of automated on-road operation, but which require or benefit from automated driving tasks being remote-controlled by the infrastructure while operating in special-use environments. Such special-use environments may include driving through a car wash facility, driving within the hull of an ocean ferry or driving within a railcar.

The interaction between the server 220 and the vehicle processing module begins in step 401 when a need to remotely control the vehicle 200 arises. This need arises, for example, when assembly of a new vehicle in a manufacturing plant has been completed and the vehicle 200 is ready to ship. In this case, the vehicle 200 must initially be moved from the end of the manufacturing line to a temporary parking position.

At a high level, the server 220 executed a loop in which it determines an accurate position of the vehicle, calculates a path the vehicle should take to drive to a next waypoint, and provide the path within a motion request to the vehicle which executes the request and drives to the next waypoint.

More specifically, at the beginning of a waypoint loop 420 the server 220 communicates a position request message 402 to the vehicle processing module 301. The vehicle processing module responds with a vehicle position message 403. The vehicle position message may reference the vehicle's position in real world coordinates, for example in WSG 84 coordinates. The vehicle may determine its position based on a GNSS system, which will inherently have limited accuracy and may, by itself, be insufficient to provide the necessary accuracy to initiate automated movement of the vehicle 200.

Therefore, in a refine position step 406 the server 220 determines an accurate vehicle position by acquiring and processing data from a stationary sensor. The server 220 may in particular use the low accuracy position received in the vehicle position message 403 to identify the vehicle 200 within the view of a stationary sensor. The server may then use more accurate position information derived from the stationary sensor in a refine position step 406. Based thereon, the server 220 may determine the path of the vehicle in a path determination step 407. Beneficially, the server 220 may determine the position of the vehicle 200 with higher accuracy than is available within the vehicle processing module 301. For example, the server 220 may determine the position of the vehicle 200 with an accuracy of ±5 cm and possibly within ±1 cm.

The server 220, in an obstacle identification step 431, identifies obstacles within the path of the vehicle 200 between the vehicle's present position and at least the next waypoint. If no obstacles are present, the server 220 transmits a motion request message 421 to the vehicle processing module 301. While the vehicle is moving, the server 220 executes a drive authorization loop 430 in which it identifies obstacles which may enter the path of the vehicle 200, and absent any obstacles sends a motion valid message 432 to the vehicle. Receipt of the motion valid message 432 authorizes the vehicle processing module 301 to execute the motion request 421 by controlling vehicle actuators, e.g. the vehicle's transmission, engine, and steering. The vehicle processing module updates the server 220 with a vehicle position message 433. The drive authorization loop 430 is preferably executed with a loop time of 1 second or less. The vehicle processing module 301 may be configured to maintain lateral and longitudinal motion of the vehicle 200 only until the next motion valid message 432 is expected. If a motion valid message is not received as expected, the vehicle processing module 301 may stop the vehicle 200.

When the vehicle reaches the waypoint it may send a waypoint reached message 422 to the server 220. Reaching the waypoint starts a new iteration of the waypoint loop 420. Waypoint may be spaced at various distances. For example, waypoints may be spaced several meters or even several hundred meters apart. In other applications, waypoints may be spaced less than 10 m and possibly less than 1 m apart.

Inaccuracy of the vehicle position message 403, 433 is corrected in the refine position step 406 performed by the server, and the path from the waypoint which has just been reached to the next waypoint which is calculated in step 407 is based on the more accurate position available to the server 220 based on its use of stationary sensors. While traveling from one waypoint to the next, the vehicle may follow a path autonomously based on dead reckoning utilizing vehicle sensors. Once a waypoint is reached, the inevitable position error that accumulates through dead reckoning is corrected with the help of stationary sensors.

The waypoint loop 420 is completed when the vehicle reaches its destination in step 422.

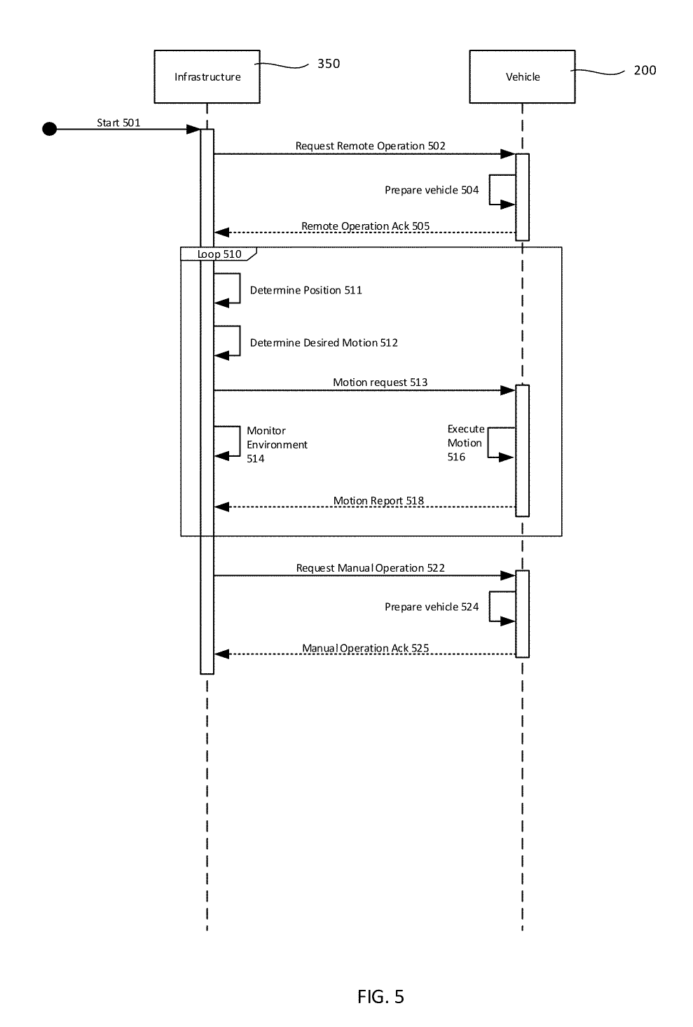

Referring now to FIG. 5, an alternative sequence diagram shows an exemplary interaction between the infrastructure 350 and the vehicle 200. The interaction may apply to a vehicle 200 within a special-use environment, such as self-propelled driving of the vehicle 200 through a car wash facility. One skilled in the art will recognize that while the example of a car wash is being described, the concepts disclosed herein apply to many other off-road use cases.

The interaction between the infrastructure 350, here a car wash facility, and the vehicle 200 begin in step 501 when the vehicle enters the car wash facility at a designated drop-off location. The vehicle 200 may have been driven to the car wash facility under human control in a manual operating mode.

The infrastructure 350 transmits a remote operation request 502 to the vehicle 200. The remote operation request 502 may be sent directly to the vehicle 200, e.g. through a wireless interface. Alternatively, the remote operation request 502 may be transmitted from the car wash facility to a telematics control center, which in turn communicates the request 502 to the vehicle 200. In this context, the infrastructure 350 may thus include local premised in the vicinity of the vehicle 200 as well as remote facilities such as a telematics control center which may regularly communicate with the vehicle 200.

In a vehicle preparation step 504 the vehicle may perform a series of checks and actions to prepare the vehicle for remote-controlled operation. Remote-controlled operation may include automated and/or driverless operation. The vehicle 200 may, for example, check the location of the vehicle 200 against an on-board database to verify that the vehicle is within a qualified remote-controlled operation area. In the exemplary case of a carwash special-use, the vehicle 200 may e.g. compare its GNSS world coordinates with a table of known car wash location to accept or reject the remote operation request 502. This check provides a safeguard against incorrect activation of automated vehicle operation outside of qualified off-road areas. The vehicle 200 may also perform actions such as closing windows and sunroofs to prepare for remote operation. The preparation step 504 may include confirming, by evaluation of on-board sensors, that no occupants are present in the vehicle.

After all preparatory actions have been completed and if all required conditions for remote operation have been met, the vehicle will switch into a remote-controlled operating mode and acknowledge its readiness for remote operation with an acknowledgement message 505 to the infrastructure.

The infrastructure 350 may then enter an remote operation loop 510 which includes several steps that are consecutively performed. In a position determination step 511 the infrastructure may determine the position of the vehicle 200, e.g. its position with the car wash facility. The position determination step 511 may be based on one or more infrastructure sensors. In case of a car wash facility, these infrastructure sensors may include overhead camera sensors, light beam curtains, inductive or capacitive position sensors, and the like. The use of infrastructure sensors to determine the position of the vehicle in step 511 is required, since on-board sensors within the vehicle 200, e.g. Lidar, radar, and camera sensors, will be subjected to blockage while the vehicle is being washed.

Based on the position of the vehicle 200 within the car wash facility, the infrastructure 350 may, in a motion determination step 512, determine a desired motion action. The desired motion action may include determining that the vehicle should move forward with a particular speed by a particular distance. The desired motion action may include lateral motion correction to ensure that the vehicle moves through the car wash following a predetermined path. In conventional car wash facilities that path is straight. In combination with the present disclosure the self-propelled movement of the vehicle through a car wash facility also allows the vehicle to follow a curved path through the car wash.

The desired motion action established in the motion determination step 512 is consecutively communicated from the infrastructure 350 to the vehicle 200 in a motion request message 513. The motion request message 513 may include information such as longitudinal motion distance, longitudinal speed, lateral motion distance, lateral speed, and steering angle. An exemplary motion request message might instruct a vehicle to move forward 0.5 m at a speed of 0.3 m/s, turning right by 0.4 degrees. When the vehicle reaches a specific piece of car wash equipment, e.g. when the tires reach a tire cleaning brush, the infrastructure may instruct the vehicle to stop. The self-propelled motion of a vehicle through a car wash facility may thus lead to improved cleaning over traditional conveyor based systems by more effectively utilizing cleaning equipment.

The vehicle executes the requested motion in a motion execution step 516. The motion execution step 516 may include the use of open or closed-loop control mechanisms within the vehicle 200. To follow an instruction such as the exemplary motion request to move forward by 0.5 m, the vehicle processing module 301 may instruct a longitudinal motion controller to assume the instructed speed of 0.3 m/s. The vehicle processing module 301 may simultaneously monitor wheel pulse sensors to determine the distance travelled, and instruct the longitudinal motion controller to stop the vehicle when a predetermined number of wheel pulses have been registered, indicating that the desired distance of 0.5 m has been reached. Similarly, the vehicle processing module 301 may instruct a steering control system to apply a certain steering torque, monitor a steering angle sensor, and reduce the steering torque to 0 when the steering angle has changed by the instructed value of 0.4 degrees.

While the vehicle executes its motion request, the infrastructure may continuously monitor the car wash facility as indicated by an environment monitoring step 514. The environment monitoring may include evaluation of infrastructure sensors, e.g. a door contact switch or a motion sensor, to ensure that no humans are present inside the car wash facility through which the vehicle 200 moves in a self-propelled manner. If a breach of the environment is observed, the infrastructure 350 may send motion requests 513 to all vehicles under its supervision to stop immediately. Preferably, the motion request 513 instructs the vehicle 200 to move only a short and safe distance, such that a missing subsequent motion request during the next iteration of the loop 510 provides an automatic fail-safe, e.g. in case of an infrastructure failure or communication failure between the infrastructure and the vehicle.

The vehicle 200 may continuously report progress of its motion execution with a motion report 518 to the infrastructure.

Once the vehicle 200 reaches the end of the car wash facility, the infrastructure 350 may request the vehicle 200 to switch back into a manual operational mode by transmitting a manual operation request message 522. The vehicle may perform actions and test to verify that manual operation has been restored and confirm the manual operation mode with an acknowledgement message 525.

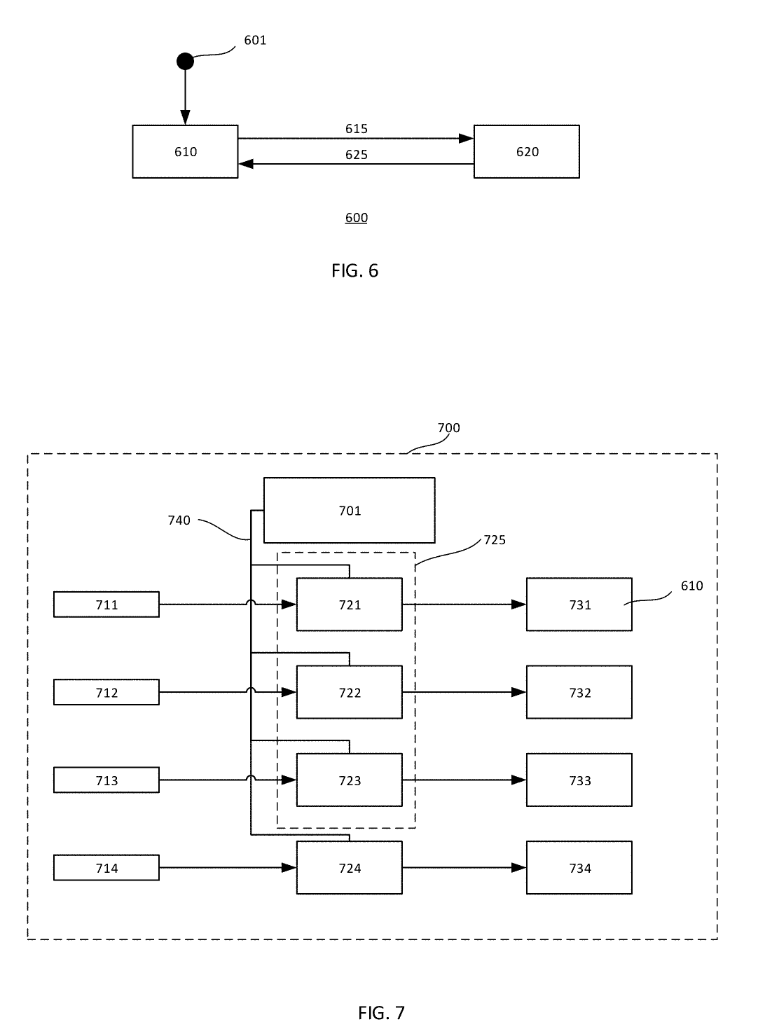

Referring to the state machine 600 shown in FIG. 6, the vehicle 200 as described can operate in a regular mode 610 and in a remote-controlled mode 620. While in the regular mode 610, the vehicle may perform functions common during on-road use. In particular, the vehicle may travel on-road under human control. The vehicle may be longitudinally controlled by the human driver through operation of an accelerator pedal and a brake pedal. The vehicle may be laterally controlled by operation of a steering wheel. Alternatively, the vehicle may operate automatically on-road, provided it is so equipped, based on suitable sensors and processing modules.

A vehicle which implements the state machine 600 may utilizes a forward facing camera and ultrasonic sensors. The camera may be a 180 degree field of view camera used within a surround view system. A GNSS locating system may be used to determine the position of the vehicle. The vehicle may be in bidirectional communication with a server, e.g. through a telematics device. These hardware components are commonly found on many vehicles, but are generally insufficient for automated driving.

For use within the confines of a privately owned vehicle assembly plant, a rental car lot, or a car wash facility, i.e. at places which are not publicly accessible but to which access is rather tightly controlled, these sensors are however sufficient to enable automated, remote-controlled driving without a human driver on board. The vehicle may transition from the regular mode 610 to the remote-controlled mode 620. While the remote-controlled mode 620 is active, the vehicle 200 may respond to external motion requests. The transition 615 from the regular mode 610 to the remote-controlled mode 620 is preferably conditioned on multiple safeguards:
1. The remote-controlled mode 620 may only be enabled when the vehicle is in a “logistic mode” which may have been activated at end of a vehicle assembly line as described e.g. in EP 1081898.
2. The remote-controlled mode 620 may only be enabled through a secure communication with the server and only after the server has been authenticated.
3. The remote-controlled mode 620 may only be enabled when the vehicle determines that its location is within a predetermined geographic area. That is, remote-controlled operation may be geo-fenced to the predetermined confines of a specific area, e.g. a parking lot within a vehicle assembly plant.
4. The remote-controlled mode 620 may only be enabled when the vehicle detects a taxi lane marking within a predetermined region of interest in an image captured by a longitudinally arranged camera. The longitudinally arranged camera may be forward-facing or rear-facing.
5. The remote-controlled mode 620 may only be enabled if on-board vehicle sensors indicate that no occupants are present inside the vehicle.

These safeguards are designed to prevent accidental activation of the remote-controlled mode 620 outside of dedicated areas, e.g. parking lots used for vehicle logistics purposes. One skilled in the art will recognize that many other safeguards may be desirable.

While moving in the remote-controlled mode 620, the vehicle may be following dedicated taxi lane markings that are painted onto roadways within the parking lot. This simplifies the path determination while the vehicle is in the remote-controlled mode. The detection of taxi lane markings may be based on computer vision algorithms. The detection of taxi lane markings may recognize branches (branch left, branch right, branch left and right) and stop lines. While moving in remote-controlled mode, the server may provide instructions to the vehicle as a sequence of maneuvers such as “straight at first branch, left at second branch, stop at line”. Alternatively or additionally, the vehicle may receive instructions from the server to follow another vehicle.

While moving in remote-controlled mode, the vehicle may be using distance sensors and cameras to detect obstructions in the path of the vehicle, automatically stop when an obstruction has been detected, and communicate to the server that an obstruction blocks the path of the vehicle. Said more simply, the vehicle may call for human backup when it gets stuck.

As shown in FIG. 1, the vehicle may be manually driven to a drop off location from where it automatically drives into one of several FIFO lanes. While parked in the FIFO lane the vehicle may periodically communicate with the server. More specifically, whenever the front-most vehicle from the FIFO lane moves towards a pickup location, the server may communicate with each vehicle in the FIFO lane and direct each vehicle to move forward by one car length.

FIFO lanes are preferably organized by destination (in case of a vehicle plant) or by vehicle class (in case of a rental car lot). The pickup location may be a dedicated location from which the vehicle may be driven under human control. Consequently, the pickup location may be located at the border of the geo-fenced area that allows remote-controlled driving. Also, taxi lane markings may end at the pickup location, preventing the vehicle to drive beyond the pickup location.

While driving in remote-controlled mode 620, the vehicle speed may be limited to reflect the limited range of the envisioned low cost ultrasonic sensors and surround view camera systems. The wide field of view of the envisioned 180 degree camera inevitably reduces the range in which a computer vision algorithm can detect objects. More specifically, the sensor range to reliably detect an object may be as short as 1 meter. Also, the vehicle may be decelerated with no more than 3 m/s². Given these constraints, a maximum speed of the vehicle while traveling in remote-controlled mode of no more than 0.66 m/s or 2.4 km/h may be allowed. While this may be too slow for use in public places, it is more than fast enough for the planned use in e.g. a vehicle assembly plant. Even high capacity plants will usually not produce more than 1 vehicle every 30 seconds. If a vehicle is allowed to travel from the end of line to its destination at a speed of just 0.5 m/s it will be 15 meters away by the time the next car leaves the assembly line.

In order to even further reduce hardware cost and enable low-cost vehicles to benefit from being part of an automated vehicle logistics system, the vehicles may travel in reverse while moving in remote-controlled mode. This allows use of a backup camera, which in the US is mandatory equipment for vehicles under FMVSS 111, for object detection and lane tracking in combination with rear ultrasonic sensors, which are more commonly deployed than ultrasonic sensors in the front of the vehicle.

Referring now to FIG. 7, a vehicle 700 includes an accelerator pedal 711, a brake pedal 712, a shifter 713 and a steering wheel 714, allowing a human driver to control the longitudinal and lateral motion of the vehicle while the vehicle is operating in a regular mode.

The accelerator pedal 711 is operatively connected to an acceleration controller 721, which may be a software component within an engine control module. Operation of the accelerator pedal causes a change of data in the engine controller. The accelerator pedal is thus operatively connected to the engine controller. The accelerator pedal may include a potentiometer, an inductive sensor or a magnetic sensor which is wired into an input of the engine controller. Alternatively, the accelerator pedal may communicate a pedal position digitally, e.g. through a LIN bus, CAN bus, or using the SENT (SAE J2716) protocol. The longitudinal motion controller 721 is operatively connected to the vehicle's propulsion system 731, e.g. its internal combustion engine or electric motor.

Similarly, the brake pedal 712 is operatively connected to a brake controller 722, which may be a software component within a larger vehicle stability control system. The brake controller is operatively connected to the vehicle's brakes 732.

A shifter 713 is operatively connected to a transmission controller 723, which may be a software component within a transmission control module. The transmission control module is operatively connected to a transmission 733. In vehicles having an internal combustion engine the shifter 713 may be a “PRNDL” type shifter affecting an automatic transmission 733. In vehicles having an electric motor the shifter 713 may be of a “PRD” type, allowing a driver to select at least the direction of vehicle travel (forward or reverse) and to engage a park mode, affecting a motor controller. The transmission controller 723 may be a travel direction controller.

The brake controller 722, the acceleration controller 721, and the transmission controller 723 may be part of or jointly form a longitudinal motion controller 725. For that purpose, information related to the brake pedal 712 may be provided to the acceleration controller 721 and information related to the accelerator pedal 711 may be provided to the brake controller 722. Information may be exchanged through a serial data bus 740, e.g. through an automotive Ethernet network, a Controller Area Network (CAN bus), a Flexray bus, or a LIN bus.

A steering wheel 714 is operatively connected to a lateral motion controller 724, which may be a software component within a power steering control module. The steering wheel 714 may e.g. be mechanically connected to a steering wheel angle sensor and/or a steering torque sensor, which are electrically connected to the power steering module. In effect, operation of the steering wheel causes a change in the lateral motion controller, e.g. by changing a value in a memory component associated with the steering wheel angle or steering wheel torque. The power steering control module 724 is operatively connected to a power steering actuator 734.

An automated vehicle processing module 701 is operatively connected to the longitudinal motion controller 725 and to the lateral motion controller 724. The automated vehicle processing module may be a separate physical component having a dedicated processor. Alternatively, one or more of the lateral motion controller 724 and the longitudinal motion controller 725 including the acceleration controller 721, the brake controller 722 and the transmission controller 723, may be integrated into the automated vehicle processing module 701 and run as software modules on a common processor with shared processing and memory resources. The automated vehicle processing module 701 may also be referred to as a remote operation module.

The vehicle processing module 701 is operatively connected to a communication module, providing wireless communication with a stationary server. The vehicle processing module 701 may be the same as the vehicle processing module 301 shown in FIG. 3.

The disclosed vehicle logistics system can be used in various environments in which vehicles are presently driven by human drivers or conveyed by some form of conveyor system. These environments pose different challenges as compared to on-road driving. For example, a vehicle which is driven within a railroad car is surrounded by steel structures which may render vehicle based radar sensors unusable for their ordinary purpose during on-road driving. Similarly, a vehicle which moves through a car wash in a self-propelled manner, thereby eliminating the need for a traditional conveyor system, may not be able to rely on camera sensors and ultrasonic distance sensors as during on-road driving.

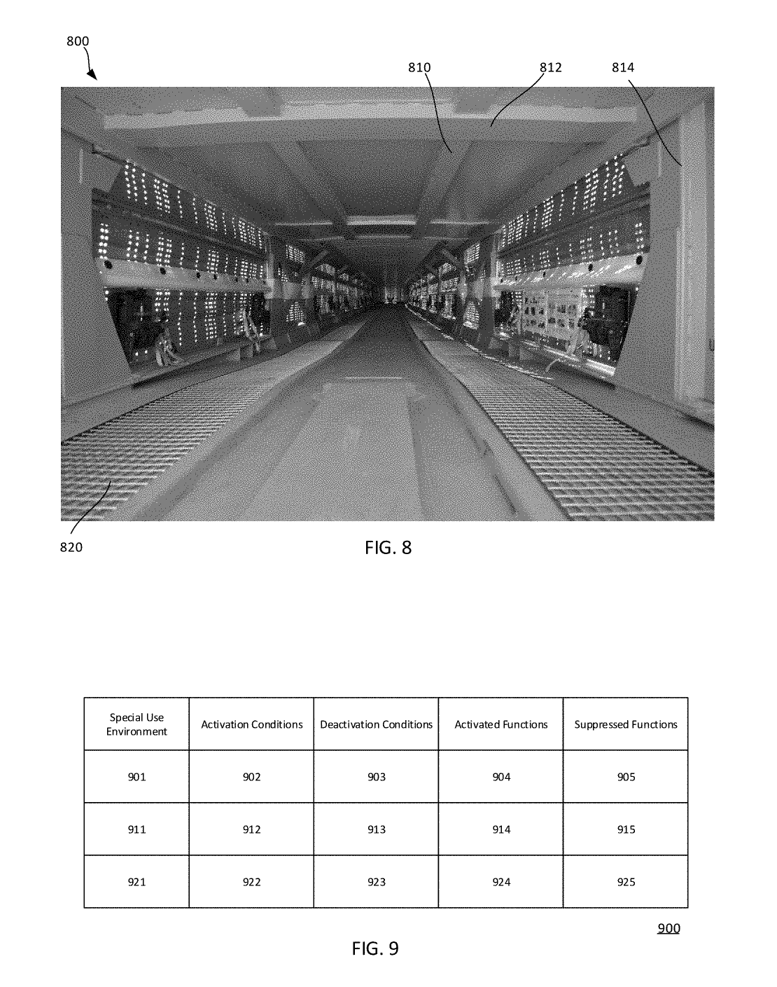

An exemplary camera view into a vehicle transport railcar 800 as it may be recorded by a forward-facing on-board camera in the vehicle 200 is shown in FIG. 8. Automated travel within the railcar 800 is considered a special-use, which may be performed only while the vehicle 200 is in a remote-controlled state 620. A typical vehicle transport railcar comprises numerous longitudinal structures 810, lateral structures 812 and vertical structures 814. Most of these structural elements 810, 812, 814 are made of steel. Within the railcar 800 vehicles travel with their tires on longitudinal tire tracks, which may be formed as steel grate flooring components 820.

Due to the large number of steel components within the railcar 800, on-board radar sensors in the vehicle 200 are typically unable to operate properly. Therefore, automated travel within the railcar 800 requires special consideration. In particular, certain functions such as a radar-based automatic emergency braking system may have to be disabled for automated travel within a railcar. While operating in the remote-controlled mode 620 the vehicle may thus disable certain functions, sensors, or processing routines that are enabled in the regular mode 610. The disabled functions, sensors and processing routines may include radar sensors, automatic emergency braking, and on-road lane keeping.

While operating in the remote-controlled mode 620, the vehicle may also enable certain functions and processing routines which are not available or executed in the regular mode 610. This includes detecting longitudinal structures within a railcar, determining a focus of expansion based on the recognition of railcar structures, centering the vehicle within the railcar, and responding to remote vehicle motion requests.

Special-use environments may require specific responses. For example, remote-controlled self-propelled motion of a vehicle within the hull of an ocean ferry may require suppressing certain functions that need not be suppressed during, remote-controlled self-propelled motion inside a railcar. Similarly, remote-controlled motion of a vehicle within the hull of an ocean ferry may require activating certain functions that need not be activated during remote-controlled self-propelled motion inside a railcar.

Therefore, it is beneficial to maintain within the vehicle a table 900 which associates special-use environments with a list of suppressed and activated functions as shown in FIG. 9. The table 900 preferably also includes activation conditions which determine the transition from regular mode to remote-controlled mode and deactivation conditions which determine the transition from remote-controlled mode to regular mode.

The table 900 may e.g. be implemented in form of a data structure stored in a memory component within the vehicle 200, in particular within a vehicle processing module. Additionally or alternatively, the table 900 may be implemented in form of programming instructions executed by a processor within the vehicle 200, in particular within a vehicle processing module.

For example, the table 900 may contain an entry for an in-plant vehicle logistics operating environment 901. The in-plant vehicle logistics operating environment 901 may only be activated if activating conditions 902 have been met, which may include a diagnostic service being activated from a properly authenticated and authorized in-plant diagnostic tool. The activating conditions 902 may also include verifying that a geographic position as determined by a GNSS receiver falls within a predetermined geographic area encoded within the activation conditions 902. The table 900 may include deactivation conditions 903, which cause the vehicle 200 to deactivate its remote-controlled operating mode. The deactivation conditions 903 may e.g. include any of the activation conditions 902 being no longer met. The deactivation conditions 903 may include additional conditions, such as e.g. expiration of a timer since the remote-controlled operating mode has been activated. The remote-controlled operating mode may e.g. be automatically deactivated 60 minutes, 6 hours, 2 day, or 7 days after it has been activated.

While the in-plant vehicle logistics operating environment 901 is active, the vehicle may activate certain functions 904 which are not available in a normal operating mode. One exemplary such function is a speed limiter, which may limit the maximum operating speed to less than about 2 km/h-10 km/h. At the same time, the vehicle may suppress certain functions while operating within the in-plant vehicle logistics operating environment 901. This may e.g. include suppressing safeguards that prevent vehicle motion without proper control input from an accelerator pedal, brake pedal, or steering wheel.

Other special use environments 911, 921 may include operating a vehicle within a railcar, within a ferry, within a car wash facility, within a rental car lot, within a car service facility, or within an off-road parking lot. Each of the special use environments 911,921 may utilize unique activation conditions 912,922 and deactivation conditions 913,923. The vehicle 200 may be configured to activate various functions 914,924 and suppress various functions 915,925 depending on the special-use environment it is being operated in.

These special-use environments may include driving within a single- or multi-level rail car, driving within an ocean ferry, driving within a car wash. More generally, special-use environments may include driving within any form of building or structure which can impact the performance of vehicle sensors and/or the interpretation of vehicle sensor data. In such environments the augmentation of vehicle-based sensors with stationary infrastructure sensors is particularly beneficial. It is beneficial to implement a driving scenario recognition function which recognizes special-use environments

While the present invention has been described with reference to exemplary embodiments, it will be readily apparent to those skilled in the art that the invention is not limited to the disclosed or illustrated embodiments but, on the contrary, is intended to cover numerous other modifications, substitutions, variations and broad equivalent arrangements that are included within the spirit and scope of the following claims.

What is claimed is:

1. A logistic system, comprising:
a vehicle having
an accelerator pedal operatively connected to a longitudinal motion controller,
a brake pedal operatively connected to the longitudinal motion controller,
a steering wheel operatively connected to a lateral motion controller, and
an automated vehicle processing module operatively connected to the longitudinal motion controller and to the lateral motion controller,
wherein the vehicle is configured to operate in different operating modes, the operating modes including a regular mode and a remote-controlled mode;
a server wirelessly communicating with the automated vehicle processing module; and
a stationary sensor operatively connected to the server, the sensor having a field of view which includes a path of the vehicle,
wherein the server is configured
to processes data received from the stationary sensor and determine a position of the vehicle based on the data received from the stationary sensor,
to determine a presence of objects within the path of the vehicle, and
to communicate vehicle motion instructions to the automated vehicle processing module, and
wherein the automated vehicle processing module is configured to control the longitudinal motion and lateral motion of the vehicle based on the vehicle motion instructions received from the server while the vehicle is operating in the remote control mode.

2. The logistic system as in claim 1,
wherein the vehicle motion instructions include distance information, and
wherein the vehicle follows the vehicle motion instructions by controlling the vehicle's speed, and
wherein the vehicle determines the vehicle's position while following the vehicle motion instruction by evaluating at least one dead reckoning sensor.

3. The logistic system as in claim 1,
wherein the stationary sensor is attached to a ceiling structure of an ocean ferry or a railcar.

4. The logistic system as in claim 1, wherein the vehicle motion instructions cause the vehicle to move from an area proximal to the end of a vehicle assembly line to a parking area within a vehicle assembly plant.

5. The logistic system as in claim 1, wherein the vehicle motion instructions cause the vehicle to move self-propelled through a car wash facility.

6. A vehicle, comprising:
an accelerator pedal operatively connected to a longitudinal motion controller;
a brake pedal operatively connected to the longitudinal motion controller;
a steering wheel operatively connected to a lateral motion controller; and
an automated vehicle processing module operatively connected to the longitudinal motion controller and to the lateral motion controller,
wherein the vehicle is configured to operate in different operating modes, the operating modes including a regular mode and a remote-controlled mode, and
wherein the automated vehicle processing module is configured to control the longitudinal motion and lateral motion of the vehicle based on vehicle motion instructions received wirelessly from a server while the vehicle is operating in the remote control mode.

7. The vehicle as in claim 6, further comprising:
a longitudinally arranged camera having a field of view which includes a portion of a surface on which the vehicle is moving; and
an image processing module operatively connected to the camera, the image processing module being configured to determine, by evaluation of images captured by the camera, a position of the vehicle relative to a visible structure or marking on the surface.

8. The vehicle as in claim 7, wherein the visible structure or marking is a taxiway centerline marking or a longitudinal structure within a railcar.

9. The vehicle as in claim 6,
wherein the vehicle is configured to enable a function while in remote controlled mode that is not being executed while in regular mode, and
wherein the vehicle is configured to suppress a function while in remote controlled mode that is being executed while in regular mode.

10. The vehicle as in claim 6,
wherein the vehicle is configured to not travel further than a predetermined distance and/or not longer than for a predetermined time after receiving a vehicle motion instruction.

11. The vehicle as in claim 6,
wherein the vehicle is configured to stop when communication with the server is lost.

12. The vehicle as in claim 6,
wherein the vehicle is configured to transition from the remote control mode to the regular mode when the brake pedal is activated.
